(19) United States
(12) Patent Application Publication
(10) Pub. No.: US 2025/0301320 A1
(43) Pub. Date: Sep. 25, 2025

(54) PREVENTING ATTACKS IN A MIXED WPA2 AND WPA3 ENVIRONMENT

(71) Applicant: QUALCOMM INCORPORATED, San Diego, CA (US)

(72) Inventors: Xin DENG, Shanghai (CN); Hu WANG, Shanghai (CN); Wenchao LI, Shanghai (CN); Kun XIE, Yangpu (CN); Sijun WU, Shanghai (CN); Wensong LI, Shanghai (CN)

(21) Appl. No.: 18/863,968

(22) PCT Filed: Jul. 7, 2022
(86) PCT No.: PCT/CN2022/104320

§ 371 Date: Nov. 7, 2024

(51) Int. Cl. H04W 12/06; H04W 8/00; H04W 12/08

(52) U.S. Cl. CPC H04W 12/06; H04W 8/005; H04W 12/08

(57) ABSTRACT

This disclosure provides methods, devices and systems for improving security in wireless communication networks. An example method includes scanning a wireless medium for a presence of access points (APs) in a wireless communication range of the first wireless STA, identifying, based on the scanning, two or more APs each having a same first Service Set Identifier (SSID), the two or more APs including a first AP that supports a Wi-Fi Protected Access (WPA) 3 wireless security protocol and a WPA 2 wireless security protocol and including a second AP that supports the WPA 2 wireless security protocol but does not support the WPA 3 wireless security protocol, selecting a first simultaneous authentication of equals (SAE) authentication type for a first group of APs that includes the first AP based on at least one AP of the first group of APs supporting the WPA 3 wireless security protocol, and authenticating with the first AP based at least in part on the same first SSID and the first SAE authentication type.

### CROSS REFERENCE

This present Application is a 371 national stage filing of International PCT Application No. PCT/CN2022/104320 by DENG et al. entitled “PREVENTING ATTACKS IN A MIXED WPA2 AND WPA3 ENVIRONMENT,” filed Jul. 7, 2022, which is assigned to the assignee hereof, and which is expressly incorporated by reference in its entirety herein.

### TECHNICAL FIELD

This disclosure relates generally to wireless communication, and more specifically, to improving the security of wireless communication systems.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

A connection established or maintained between a STA and an AP may be secured using one or more security protocols, such as a Wi-Fi Protected Access (WPA) wireless security protocol, which may include for example a WPA 2 or a WPA 3 wireless security protocol. APs operating in accordance with WPA 2 may coexist with APs operating in accordance with WPA 3. Further, APs may operate in accordance with a WPA 3 transition mode (or mixed mode) wireless security protocol, which provides improved compatibility for STAs which are not compatible with WPA 3.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communication. The method includes scanning a wireless medium for a presence of access points (APs) in a wireless communication range of the first wireless STA, identifying, based on the scanning, two or more APs each having a same first Service Set Identifier (SSID), the two or more APs including a first AP that supports a Wi-Fi Protected Access (WPA) 3 wireless security protocol and a WPA 2 wireless security protocol and including a second AP that supports the WPA 2 wireless security protocol but does not support the WPA 3 wireless security protocol, selecting a first simultaneous authentication of equals (SAE) authentication type for a first group of APs that includes the first AP based on at least one AP of the first group of APs supporting the WPA 3 wireless security protocol, and authenticating with the first AP based at least in part on the same first SSID and the first SAE authentication type.

Another innovative aspect of the subject matter described in this disclosure can be implemented in a wireless communication device. The wireless communication device includes at least one modem, at least one processor communicatively coupled with the at least one modem, and at least one memory communicatively coupled with the at least one processor. The at least one memory stores processor-readable code that, when executed by the at least one processor in conjunction with the at least one modem, is configured to scan a wireless medium for a presence of access points (APs) in a wireless communication range of the first wireless STA, identify, based on the scanning, two or more APs each having a same first Service Set Identifier (SSID), the two or more APs including a first AP that supports a Wi-Fi Protected Access (WPA) 3 wireless security protocol and a WPA 2 wireless security protocol and including a second AP that supports the WPA 2 wireless security protocol but does not support the WPA 3 wireless security protocol, select a first simultaneous authentication of equals (SAE) authentication type for a first group of APs that includes the first AP based on at least one AP of the first group of APs supporting the WPA 3 wireless security protocol, and authenticate with the first AP based at least in part on the same first SSID and the first SAE authentication type.

In some implementations, the first AP is associated with a 5 GHz frequency band and the second AP is associated with a 2.4 GHz frequency band. In some aspects, the first groups of APs includes the second AP. In some aspects the second AP is in a second group of APs not including the first AP.

In some implementations, the methods and wireless communication devices may be configured to provide results of the scanning, including the first group of APs, to a user interface of the first wireless STA, and receive a request from the user interface to authenticate with an AP of the first group of APs, wherein authenticating with the first AP is in response to receiving the request. In some aspects receiving the request to connect includes receiving a selection of the first group of APs from the user interface.

In some implementations, authenticating with the first AP may include sending a request to a supplicant of the first wireless STA, where the request indicates the first SSID and the first SAE authentication type. In some aspects, the supplicant authenticates with the first AP based at least on the first SAE authentication type and the first SSID.

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 shows a pictorial diagram of an example wireless communication network.

FIG. 2 shows a block diagram of an example wireless communication device.

FIG. 3A shows a block diagram of an example access point (AP).

FIG. 3B shows a block diagram of an example station (STA).

FIG. 4 shows a time sequence diagram illustrating a conventional STA's vulnerability to a malicious actor.

FIG. 5 shows a time sequence diagram showing an example selection and connection to an AP by a wireless communication device.

FIG. 6 shows a flowchart illustrating an example process that supports improved security in wireless communication according to some implementations.

FIG. 7 shows a block diagram of an example wireless communication device that supports improved security in wireless communication according to some implementations.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU)-MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

Some aspects more specifically relate to scanning a wireless communication range of a first STA and identifying two or more APs each having the same Service Set Identifier (SSID), based on the scanning. Conventional techniques may prioritize compatibility, grouping APs based on their SSID, and assigning an authentication type which is most compatible with the group. Thereafter, on receiving a request to an AP of the group, such conventional techniques may prioritize connecting to an AP based on its frequency band, for example prioritizing an AP operating on a 5 GHz frequency band over another AP operating on a 2.4 GHz frequency band. Thus, conventional techniques may undesirably connect to an AP employing the less secure but more widely compatible WPA 2, even in the presence of another AP having the same SSID and employing the more secure WPA 3. This presents an opportunity for malicious actors, as a malicious actor may monitor signals exchanged with an AP operating in accordance with the less secure WPA 2 in a vicinity of and sharing a SSID with a non-malicious AP operating in accordance with the more secure WPA 3. Such a malicious actor may be able to determine a password associated with this WPA 2 AP, may be able to decrypt packets sent to the WPA 2 AP, may be able to replay packets sent to the WPA 2 AP, and may be able to forge packets sent to the WPA 2 AP. For example such a malicious actor may be able to compromise the WPA 2 AP using an offline dictionary attack or other vulnerabilities. In some cases the malicious actor may use this password to generate a fraudulent AP masquerading as the WPA 2 AP, for example in order to compromise STAs and other connecting devices.

Various aspects relate generally to the improvement of security in wireless networking environments including access points (APs) operating in accordance with Wi-Fi-Protected Access (WPA) 2 and WPA 3 wireless security protocols. In some aspects, a STA may be configured to prioritize connection to an AP operating with WPA 3 (via a simultaneous authentication of equals (SAE) authentication type) in contrast to conventional techniques, where a STA may prioritize connection to an AP based on the frequency band over which the AP operates or based on a most compatible (but potentially least secure) authentication type supported by a group of APs sharing a SSID. In some other examples, a STA may be configured to present two APs having the same SSID separately, rather than grouping them, in order to reduce the likelihood that the STA automatically authenticates with the less secure WPA 2 AP in the presence of a more secure WPA 3 AP.

Particular aspects of the subject matter described in this disclosure can be implemented to realize one or more of the following potential advantages. In some examples, the described techniques can be used to improve security of a wireless networking environment by reducing the chances that a STA authenticates with an AP operating in accordance with the less secure WPA 2 protocol and increasing the chances that the STA authenticates with an AP operating in accordance with the more secure WPA 3 protocol, when the WPA 2 AP and the WPA 3 AP have the same Service Set Identifier (SSID). Such prioritization of the WPA 3 protocol may reduce the likelihood that a malicious actor compromises the network by monitoring signals exchanged with the less secure WPA 2 AP.

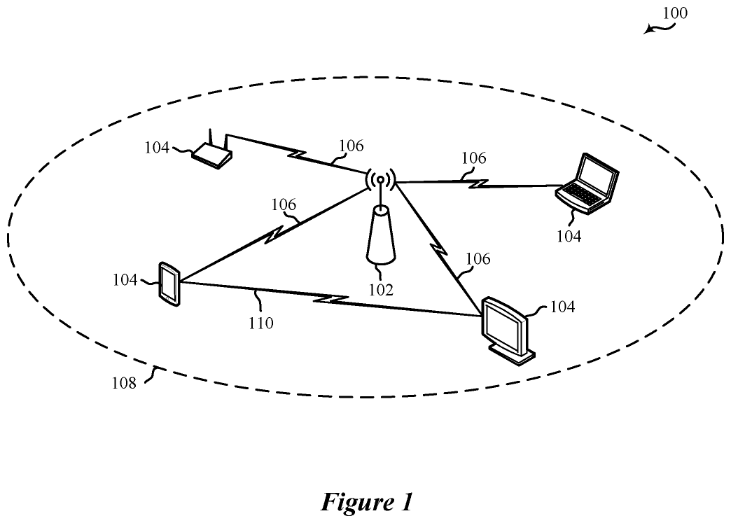

FIG. 1 shows a block diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2016 specification or amendments thereof including, but not limited to, 802.11ay, 802.11ax, 802.11az, 802.11ba and 802.11be). The WLAN 100 may include numerous wireless communication devices such as an access point (AP) 102 and multiple stations (STAs) 104. While only one AP 102 is shown, the WLAN network 100 also can include multiple APs 102.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other examples.

A single AP 102 and an associated set of STAs 104 may be referred to as a basic service set (BSS), which is managed by the respective AP 102. FIG. 1 additionally shows an example coverage area 106 of the AP 102, which may represent a basic service area (BSA) of the WLAN 100. The BSS may be identified to users by a basic service set identifier (BSSID), as well as to other devices by a Service Set Identifier (SSID), which may be a medium access control (MAC) address of the AP 102. The AP 102 periodically broadcasts beacon frames (“beacons”) including the SSID to enable any STAs 104 within wireless range of the AP 102 to “associate” or re-associate with the AP 102 to establish a respective communication link 108 (hereinafter also referred to as a “Wi-Fi link”), or to maintain a communication link 108, with the AP 102. For example, the beacons can include an identification of a primary channel used by the respective AP 102 as well as a timing synchronization function for establishing or maintaining timing synchronization with the AP 102. The AP 102 may provide access to external networks to various STAs 104 in the WLAN via respective communication links 108.

To establish a communication link 108 with an AP 102, each of the STAs 104 is configured to perform passive or active scanning operations (“scans”) on frequency channels in one or more frequency bands (for example, the 2.4 GHz, 5 GHZ, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (us)). To perform active scanning, a STA 104 generates and sequentially transmits probe requests on each channel to be scanned and listens for probe responses from APs 102. Each STA 104 may be configured to identify or select an AP 102 with which to associate based on the scanning information obtained through the passive or active scans, and to perform authentication and association operations to establish a communication link 108 with the selected AP 102. For example, when the AP 102 operates in accordance with the WPA 2 wireless security protocol, the authentication and association operations may include a 4 way handshake between the AP 102 and the STA 104. When the AP 102 operates in accordance with the WPA 3 wireless security protocol, the authentication and association operations may include authentication according to a simultaneous authentication of equals (SAE) authentication type. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may be configured to periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such implementations, while the STAs 104 may be capable of communicating with each other through the AP 102 using communication links 108, STAs 104 also can communicate directly with each other via direct wireless links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 108) according to the IEEE 802.11 family of wireless communication protocol standards (such as that defined by the IEEE 802.11-2016 specification or amendments thereof including, but not limited to, 802.11ay, 802.11ax, 802.11az, 802.11ba and 802.11be). These standards define the WLAN radio and baseband protocols for the PHY and medium access control (MAC) layers. The APs 102 and STAs 104 transmit and receive wireless communications (hereinafter also referred to as “Wi-Fi communications”) to and from one another in the form of PHY protocol data units (PPDUs) (or physical layer convergence protocol (PLCP) PDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the APs 102 and STAs 104 described herein also may communicate in other frequency bands, such as the 6 GHz band, which may support both licensed and unlicensed communications. The APs 102 and STAs 104 also can be configured to communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4, 5 GHz or 6 GHZ bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or CCC20 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

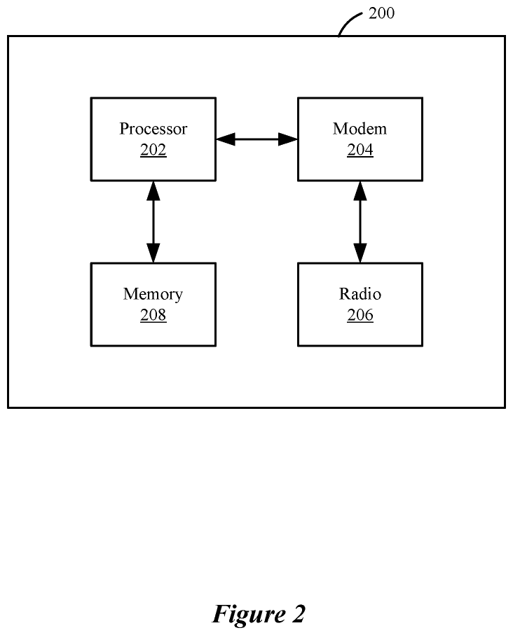

FIG. 2 shows a block diagram of an example wireless communication device 200. In some implementations, the wireless communication device 200 can be an example of a device for use in a STA such as one of the STAs 104 described above with reference to FIG. 1. In some implementations, the wireless communication device 200 can be an example of a device for use in an AP such as the AP 102 described above with reference to FIG. 1. The wireless communication device 200 is capable of transmitting and receiving wireless communications in the form of, for example, wireless packets. For example, the wireless communication device can be configured to transmit and receive packets in the form of physical layer convergence protocol (PLCP) protocol data units (PPDUs) and medium access control (MAC) protocol data units (MPDUs) conforming to an IEEE 802.11 wireless communication protocol standard, such as that defined by the IEEE 802.11-2016 specification or amendments thereof including, but not limited to, 802.11ay, 802.11ax, 802.11az, 802.11ba and 802.11be.

The wireless communication device 200 can be, or can include, a chip, system on chip (SoC), chipset, package or device that includes one or more modems 202, for example, a Wi-Fi (IEEE 802.11 compliant) modem. In some implementations, the one or more modems 202 (collectively “the modem 202”) additionally include a WWAN modem (for example, a 3GPP 4G LTE or 5G compliant modem). In some implementations, the wireless communication device 200 also includes one or more processors, processing blocks or processing elements 204 (collectively “the processor 204”) coupled with the modem 202. In some implementations, the wireless communication device 200 additionally includes one or more radios 206 (collectively “the radio 206”) coupled with the modem 202. In some implementations, the wireless communication device 200 further includes one or more memory blocks or elements 208 (collectively “the memory 208”) coupled with the processor 204 or the modem 202.

The modem 202 can include an intelligent hardware block or device such as, for example, an application-specific integrated circuit (ASIC), among other examples. The modem 202 is generally configured to implement a PHY layer, and in some implementations, also a portion of a MAC layer (for example, a hardware portion of the MAC layer). For example, the modem 202 is configured to modulate packets and to output the modulated packets to the radio 204 for transmission over the wireless medium. The modem 202 is similarly configured to obtain modulated packets received by the radio 204 and to demodulate the packets to provide demodulated packets. In addition to a modulator and a demodulator, the modem 202 may further include digital signal processing (DSP) circuitry, automatic gain control (AGC) circuitry, a coder, a decoder, a multiplexer and a demultiplexer. For example, while in a transmission mode, data obtained from the processor 206 may be provided to an encoder, which encodes the data to provide coded bits. The coded bits may then be mapped to a number N_{SS} of spatial streams for spatial multiplexing or a number N_{STS} of space-time streams for space-time block coding (STBC). The coded bits in the streams may then be mapped to points in a modulation constellation (using a selected MCS) to provide modulated symbols. The modulated symbols in the respective spatial or space-time streams may be multiplexed, transformed via an inverse fast Fourier transform (IFFT) block, and subsequently provided to the DSP circuitry (for example, for Tx windowing and filtering). The digital signals may then be provided to a digital-to-analog converter (DAC). The resultant analog signals may then be provided to a frequency upconverter, and ultimately, the radio 204. In implementations involving beamforming, the modulated symbols in the respective spatial streams are precoded via a steering matrix prior to their provision to the IFFT block.

While in a reception mode, the DSP circuitry is configured to acquire a signal including modulated symbols received from the radio 204, for example, by detecting the presence of the signal and estimating the initial timing and frequency offsets. The DSP circuitry is further configured to digitally condition the signal, for example, using channel (narrowband) filtering and analog impairment conditioning (such as correcting for I/Q imbalance), and by applying digital gain to ultimately obtain a narrowband signal. The output of the DSP circuitry may then be fed to the AGC, which is configured to use information extracted from the digital signals, for example, in one or more received training fields, to determine an appropriate gain. The output of the DSP circuitry also is coupled with a demultiplexer that demultiplexes the modulated symbols when multiple spatial streams or space-time streams are received. The demultiplexed symbols may be provided to a demodulator, which is configured to extract the symbols from the signal and, for example, compute the logarithm likelihood ratios (LLRs) for each bit position of each subcarrier in each spatial stream. The demodulator is coupled with the decoder, which may be configured to process the LLRs to provide decoded bits. The decoded bits may then be descrambled and provided to the MAC layer (the processor 206) for processing, evaluation or interpretation.

The radio 204 generally includes at least one radio frequency (RF) transmitter (or “transmitter chain”) and at least one RF receiver (or “receiver chain”), which may be combined into one or more transceivers. For example, each of the RF transmitters and receivers may include various analog circuitry including at least one power amplifier (PA) and at least one low-noise amplifier (LNA), respectively. The RF transmitters and receivers may, in turn, be coupled to one or more antennas. For example, in some implementations, the wireless communication device 200 can include, or be coupled with, multiple transmit antennas (each with a corresponding transmit chain) and multiple receive antennas (each with a corresponding receive chain). The symbols output from the modem 202 are provided to the radio 204, which then transmits the symbols via the coupled antennas. Similarly, symbols received via the antennas are obtained by the radio 204, which then provides the symbols to the modem 202.

The processor 206 can include an intelligent hardware block or device such as, for example, a processing core, a processing block, a central processing unit (CPU), a microprocessor, a microcontroller, a digital signal processor (DSP), an application-specific integrated circuit (ASIC), a programmable logic device (PLD) such as a field programmable gate array (FPGA), discrete gate or transistor logic, discrete hardware components, or any combination thereof designed to perform the functions described herein. The processor 206 processes information received through the radio 204 and the modem 202, and processes information to be output through the modem 202 and the radio 204 for transmission through the wireless medium. For example, the processor 206 may implement a control plane and at least a portion of a MAC layer configured to perform various operations related to the generation, transmission, reception, and processing of MPDUs, frames or packets. In some implementations, the MAC layer is configured to generate MPDUs for provision to the PHY layer for coding, and to receive decoded information bits from the PHY layer for processing as MPDUs. The MAC layer may further be configured to allocate time and frequency resources, for example, for OFDMA, among other operations or techniques. In some implementations, the processor 206 may generally control the modem 202 to cause the modem to perform various operations described above.

The memory 204 can include tangible storage media such as random-access memory (RAM) or read-only memory (ROM), or combinations thereof. The memory 204 also can store non-transitory processor-or computer-executable software (SW) code containing instructions that, when executed by the processor 206, cause the processor to perform various operations described herein for wireless communication, including the generation, transmission, reception, and interpretation of MPDUs, frames or packets. For example, various functions of components disclosed herein, or various blocks or steps of a method, operation, process, or algorithm disclosed herein, can be implemented as one or more modules of one or more computer programs.

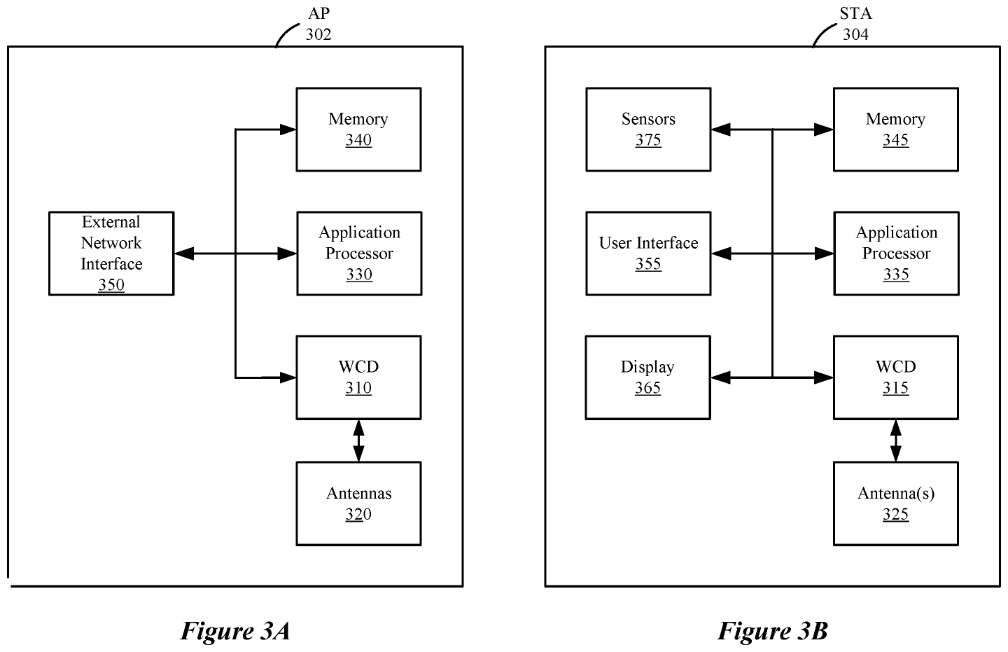

FIG. 3A shows a block diagram of an example AP 302. For example, the AP 302 can be an example implementation of the AP 102 described with reference to FIG. 1. The AP 302 includes a wireless communication device (WCD) 310 (although the AP 302 may itself also be referred to generally as a wireless communication device as used herein). For example, the wireless communication device 310 may be an example implementation of the wireless communication device 2000 described with reference to FIG. 2. The AP 302 also includes multiple antennas 320 coupled with the wireless communication device 310 to transmit and receive wireless communications. In some implementations, the AP 302 additionally includes an application processor 330 coupled with the wireless communication device 310, and a memory 340 coupled with the application processor 330. The AP 302 further includes at least one external network interface 350 that enables the AP 302 to communicate with a core network or backhaul network to gain access to external networks including the Internet. For example, the external network interface 350 may include one or both of a wired (for example, Ethernet) network interface and a wireless network interface (such as a WWAN interface). Ones of the aforementioned components can communicate with other ones of the components directly or indirectly, over at least one bus. The AP 302 further includes a housing that encompasses the wireless communication device 310, the application processor 330, the memory 340, and at least portions of the antennas 320 and external network interface 350.

FIG. 3B shows a block diagram of an example STA 304. For example, the STA 304 can be an example implementation of the STA 104 described with reference to FIG. 1. The STA 304 includes a wireless communication device 315 (although the STA 304 may itself also be referred to generally as a wireless communication device as used herein). For example, the wireless communication device 315 may be an example implementation of the wireless communication device 200 described with reference to FIG. 2. The STA 304 also includes one or more antennas 325 coupled with the wireless communication device 315 to transmit and receive wireless communications. The STA 304 additionally includes an application processor 335 coupled with the wireless communication device 315, and a memory 345 coupled with the application processor 335. In some implementations, the STA 304 further includes a user interface (UI) 355 (such as a touchscreen or keypad) and a display 365, which may be integrated with the UI 355 to form a touchscreen display. In some implementations, the STA 304 may further include one or more sensors 375 such as, for example, one or more inertial sensors, accelerometers, temperature sensors, pressure sensors, or altitude sensors. Ones of the aforementioned components can communicate with other ones of the components directly or indirectly, over at least one bus. The STA 304 further includes a housing that encompasses the wireless communication device 315, the application processor 335, the memory 345, and at least portions of the antennas 325, UI 355, and display 365.

As described above, APs within a wireless communication range of a STA may operate in accordance with different wireless security protocols. For example, a STA may be within the wireless communication range of both a first AP operating in accordance with a WPA 3 wireless security protocol and of a second AP operating in accordance with a WPA 2 wireless communication protocol. While the STA may be capable of authenticating with either the first AP or the second AP, WPA 3 is considerably more secure than WPA 2. For example, WPA 2 is vulnerable to attack, such as offline dictionary attacks. If a malicious actor monitors a STA's attempts to authenticate with a WPA 2 AP, and more particularly monitors the four way handshake between the WPA 2 and the STA, then the malicious actor may be able to determine the password for the WPA 2 AP, and subsequently impersonate the WPA 2 AP in order to compromise devices communicating with the WPA 2 AP.

A malicious observer of this four way handshake may be able to determine the password for the WPA 2 AP, or may be able to replay, decrypt, or forge packets exchanged between the STA and the WPA 2 AP.

More recently, the WPA 3 wireless security protocol has been introduced, providing stronger protection for wireless communications. For example, rather than the 4 way handshake for WPA 2, WPA 3 employs a new handshake called Simultaneous Authentication of Equals, or SAE, which is much less subject to dictionary attacks. Some APs may also operate in a WPA 3 transition mode, which is sometimes called mixed mode, and may allow connection for STAs not compatible with WPA 3 (for simplicity, this WPA 3 transition mode will be described as WPA 3 herein). It would therefore be desirable for a STA to avoid authenticating with APs operating in accordance with WPA 2, particularly in the presence of APs operating in accordance with the more secure WPA 3.

Various aspects relate generally to the improvement of security in wireless networking environments including access points (APs) operating in accordance with Wi-Fi-Protected Access (WPA) 2 and WPA 3 wireless security protocols. Example implementations may be configured to prioritize authentication with an AP in accordance with WPA 3 (via a simultaneous authentication of equals (SAE) authentication type) in contrast to conventional techniques, where a STA may prioritize authentication with an AP based on the frequency band over which the AP operates or based on a most compatible (and least secure) authentication type supported by a group of APs sharing a SSID. In some other implementations, a STA may be configured to present two APs in two separate groups, even when the two APs share a SSID, in order to reduce the likelihood that the STA may inadvertently authenticate with the less secure WPA 2 AP in the presence of a more secure WPA 3 AP.

Particular aspects of the subject matter described in this disclosure can be implemented to realize one or more of the following potential advantages. In some examples, the described techniques can be used to prevent users from mistakenly authenticating a WPA 2 AP, and to prioritize authenticating with a WPA 3 AP, even when the WPA 2 AP and the WPA 3 AP have the same Service Set Identifier (SSID). Such prioritization may reduce the likelihood that a malicious actor may compromise the network by monitoring signals exchanged with the WPA 2 AP. Further, even without the presence of a malicious actor, aspects may improve security of the wireless networking environment by reducing chances that a user authenticates with an AP operating in accordance with the less secure WPA 2 and increasing the chances that the user authenticates with an AP operating in accordance with the more secure WPA 3.

As described above, the security of a conventional STA may be compromised when multiple APs having the same SSID are within wireless communication range of the STA. For example, when both a first AP operating in accordance with WPA 3 and a second AP operating in accordance with WPA 2 are both within the wireless communication range of the STA, a conventional STA may treat the first AP and the second AP as having the same authentication type, or “authtype”. Despite the presence of the first AP, which operates in accordance with the more secure WPA 3 using the SAE authtype, conventional STAs may set the authtype for both the first AP and the second AP to be WPA-PSK, or Wi-Fi Protected Access Pre-Shared Key, which is associated with WPA 2.

In addition, conventional STAs may place a higher priority on the AP operating in a preferred frequency band. For example, the STA may prefer to select an AP operating in the 5 GHz frequency band to an AP operating in the 2.4 GHz frequency band.

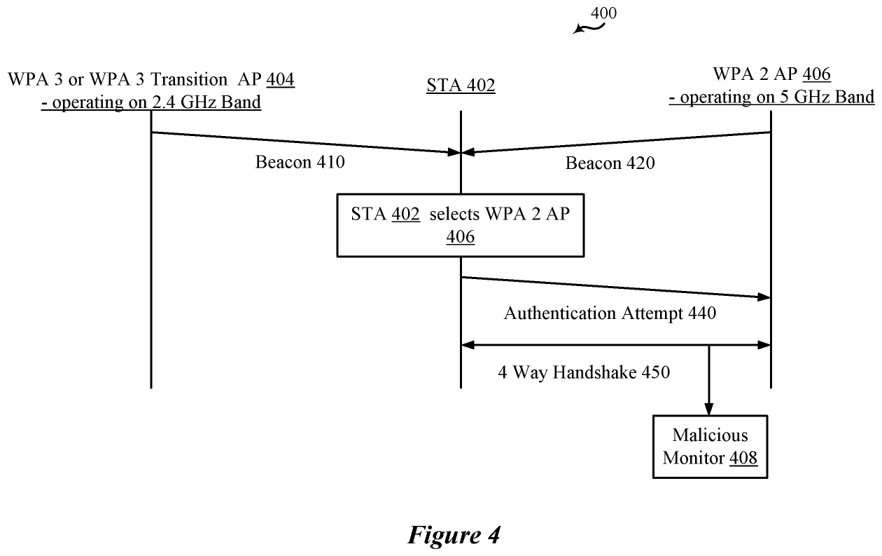

FIG. 4 shows a time sequence diagram 400 illustrating a conventional STA's vulnerability to a malicious actor. With respect to FIG. 4, a STA 402 may be within a wireless communication range of a WPA 3 or WPA 3 Transition AP 404 operating on a 2.4 GHz frequency band and a WPA 2 AP 406 operating on a 5 GHz frequency band. The STA 402 may be one example of STA 103 of FIG. 1, wireless communication device 200 of FIG. 2, or STA 304 of FIG. 3B, and the APs 404 and 406 may be examples of AP 102 of FIG. 1, wireless communication device 200 of FIG. 2, or AP 302 of FIG. 3A. The STA 402 may receive a first beacon 410 from AP 404 and a second beacon 420 from AP 406. For example, the first beacon 410 and second beacon 420 may be received by the STA 402 subsequent to the STA 402's initiation of a scan for a presence of APs within wireless communication range of the STA 402 (not shown for simplicity). As discussed above, for compatibility, the STA 402 may treat the authentication type of both the AP 404 and the AP 406 as WPA-PSK, despite AP 404 being capable of the more secure SAE authentication type. Further, because the AP 406 operates via the 5 GHz frequency band, the STA 402 may select AP 406 over the AP 404, again, despite the AP 404 operating using a more secure authentication type. Thus, the STA 402 may select (406) to authenticate with the AP 406. The STA 402 may then initiate an authentication attempt 440 to the AP 406 and engage in a 4 way handshake 450 with the AP 406. Because the AP 406 operates according to WPA 2, rather than using the more secure WPA 3, the 4 way handshake 450 may be subject to monitoring by a malicious monitor 408, who may capture the signals exchanged during the 4 way handshake 450 and compromise the security of subsequent communications with the AP 406. For example, as discussed above, compromising the security of the AP 406 may allow malicious actor to decrypt, replay, or forge packets exchanged with the AP 406, for example using an offline dictionary attack or similar. In some aspects, the malicious actor may use this password to generate a fraudulent AP masquerading as the AP 406, for example in order to compromise STAs and connecting devices.

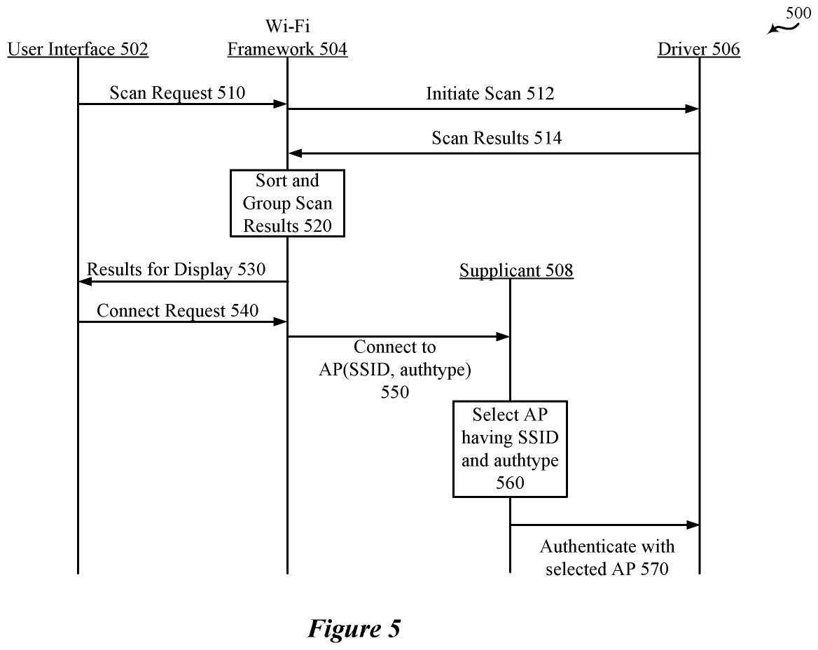

FIG. 5 shows a time sequence diagram 500 showing an example selection of and authentication with an AP by a wireless communication device. For example, the wireless communication device may be one example of STA 103 of FIG. 1, wireless communication device 200 of FIG. 2, or STA 304 of FIG. 3B. The wireless communication device performing the steps shown in the time sequence diagram 500 may include a user interface 502, a Wi-Fi framework 504, a driver 506, and a supplicant 508. The user interface 502 may present selectable options to a user for scanning and connecting to one or more APs. The Wi-Fi framework 504 may receive instructions from the user interface 502, initiate wireless scanning based on instructions from the user interface 502, receive and process scan results for display, and issue commands to the supplicant 508, for example based on instructions received from the user interface 502. The driver 506 may control one or more modems of the wireless communication device to transmit or receive signals based on instructions received from the Wi-Fi framework 504 and the supplicant 508. The supplicant 508 may be responsible for login requests to wireless networks, and more specifically may process login and encryption credentials for connection to the wireless networks, such as via one or more APs within a wireless communication range of the wireless communication device.

With respect to FIG. 5, the user interface 502 may request (510) a scan for APs within a wireless communication range of the wireless communication device by. For example, the scan may be triggered by a user selecting one or more options on the user interface 502 (not shown for simplicity). The scan request 520 may be sent to the Wi-Fi framework 504. Responsive to the scan request 510, the Wi-Fi framework 504 may send a message to the driver 506 to initiate (512) the scan. The driver 506 may perform the scan and receive one or more results of the scan. The driver 506 may return the scan results 514 to the Wi-Fi framework 504, which may sort and group the scan results (520) for presentation on the user interface 502. The sorted and grouped scan results may then be sent (530) for display at the user interface 502. A connection request 540 may be sent from the user interface 502 to the Wi-Fi framework 504. The connection request 540 may request a connection to an AP having at least a specified SSID. In some aspects, the connection request may be a request to connect to an AP from a group of APs based on the sorting and grouping (520) of the scan results. In some aspects, the connection request may be triggered by a user selecting one or more options on the user interface 502 (not shown for simplicity). In response to receiving the connection request 540, the Wi-Fi framework 504 may issue (550) connection instructions to the supplicant 508 to authenticate with an AP having a specified SSID and authentication type. The supplicant 508 may then select (560) an AP having the specified SSID and authentication type, and initiate an authentication (570) with the selected AP. For example, the supplicant 508 may select from APs having the specified SSID and authentication type based on the selected AP's operating frequency band. The supplicant may then initiate the connection with the selected AP based on the SSID and authentication type specified by the framework, as well as the BSSID of the selected AP. For example, initiating the authentication with the selected AP may include performing one or more authentication functions, such as the 4 way handshake associated with WPA 2, or the SAE authentication associated with WPA 3.

As discussed above, conventional STAs may undesirably authenticate with a WPA 2 AP, even in the presence of a WPA 3 AP. This may be due in part to the Wi-Fi framework, such as the Wi-Fi framework 504, and in part due to the supplicant, such as the supplicant 508.

For example, when sorting and grouping scan results, such as the sorting and grouping 520, the Wi-Fi framework may place a first AP and a second AP into a single group, when the first AP operates in accordance with WPA 3 or WPA 3 transition mode (mixed mode) and the second AP operates in accordance with WPA 2. Further, for broader compatibility, in conventional STAs, the Wi-Fi framework may set the authentication type for this group to be a most compatible authentication type for all APs in the group. That is, the Wi-Fi framework may set the authentication type for this group to the more insecure WPA-PSK, even though the first AP is capable of authentication according to the more secure SAE.

Further, upon receiving instructions to authenticate with an AP having a specified SSID and authentication type, the supplicant selects an AP based on the specified SSID and authentication type, such as the selection 560 of FIG. 5. In conventional STAs, the supplicant may undesirably select a WPA 2 AP for connection, even in the presence of a more secure WPA 3 AP. For example, consider the case when the first AP (WPA 3 or mixed mode) and the second AP (WPA 2) are grouped, and the first AP operates on a 2.4 GHz frequency band while the second AP operates on a 5 GHz frequency band. As discussed above, in conventional APs, the group is associated with the WPA-PSK authentication type. In a conventional STA, the supplicant may select the second AP to connect with, due to the second AP operating on the 5 GHz frequency band, even when the first AP has greater signal strength. Again, this is undesirable, as the second AP operates according to the more vulnerable WPA 2.

To avoid these vulnerabilities, the example implementations may alter the functionality of the Wi-Fi framework, the supplicant, or both.

In some aspects, the Wi-Fi framework may assign an SAE authentication type to any group containing an AP compatible with SAE, that is, an AP operating according to WPA 3 or WPA 3 transition mode (mixed mode). Rather than assigning the authentication type based on the most widely compatible authentication type supported by APs of the group, the Wi-Fi framework may assign the authentication type to be the most secure authentication type supported by any AP of the group. For example, consider again a group including the first AP (WPA 3 or mixed mode) and the second AP (WPA 2) having the same SSID. While conventional STAs may assign the WPA-PSK authentication type to this group, the example implementations may assign the SAE authentication type to this group. Consequently, when instructions are provided to the supplicant, those instructions include the SAE authentication type, and the supplicant may therefore select the more secure first AP for connection, even when the first AP operates on the 2.4 GHz frequency band and the second AP operates on the 5 GHz frequency band.

While the implementations are described above in terms of APs compatible with the WPA 3 and WPA 2 wireless security protocols, in some other implementations, an example STA may be configured to prioritize authentication with an AP compatible with a wireless security protocol more secure than WPA 3, such as a subsequent iteration of the WPA wireless security protocol, or similar. More particularly, consider a STA which scans for the presence of APs within a wireless communication range of the STA, and identifies two APs having the same SSID, a first AP compatible with a wireless security protocol more secure than WPA 3, and a second AP compatible with a less secure wireless security protocol, such as WPA 3 or WPA 2. In some aspects, the Wi-Fi framework may group the first AP and the second AP due to their sharing a SSID. The Wi-Fi framework may then assign an authentication type to the group based on the most secure authentication type supported by the group, such as the most secure authentication type supported by the first AP. Rather than assigning the authentication type based on the most widely compatible authentication type supported by APs of the group, the Wi-Fi framework may assign the authentication type to be the most secure authentication type supported by any AP of the group.

In some other aspects, rather than the Wi-Fi framework grouping APs having the same SSID but differing authentication types, example implementations may present such APs ungrouped. For example, consider again the first AP (WPA 3 or mixed mode) and the second AP (WPA 2), each having the same SSID. According to some implementations, the first AP and the second AP are not grouped in the scan results provided to the user interface, that is, the first AP may be presented in a first group, while the second AP may be presented in a second group. A user may then be less likely to inadvertently select the less secure second AP. In some aspects, to improve the chances of the user selecting the more secure first AP, the scan results may emphasize APs compatible with more secure authentication types. For example, the user interface may present APs operating according to WPA 3 higher in the list, may highlight such APs (for example using colors indicating preferability), or otherwise emphasize such APs as preferable. In addition or in the alternative, the user interface may deemphasize the display of APs having less secure authentication types. For example, the user interface may present such APs lower in the list, may fade the text associated with such APs, may highlight such APs using unfavorable colors, may deemphasize such APs, or otherwise indicate that such APs are disfavored. Further, the user interface may provide a warning message when a user elects to connect to an AP operating in accordance with WPA 2 when another AP having the same SSID is present and operating in accordance with WPA 3 or mixed mode. Such techniques may reduce the odds of a user electing to connect to a less secure WPA 2 AP in the presence of a more secure WPA 3 AP. In some other aspects, when the first AP is compatible with a wireless security protocol more secure than WPA 3, and a second AP compatible with a less secure wireless security protocol, such as WPA 3 or WPA 2, the Wi-Fi framework may not group the first AP and the second AP and may present the first AP and second AP separately in the scan results provided to the user interface. Similar techniques may be employed in order to emphasize the more secure first AP or to deemphasize the less secure second AP.

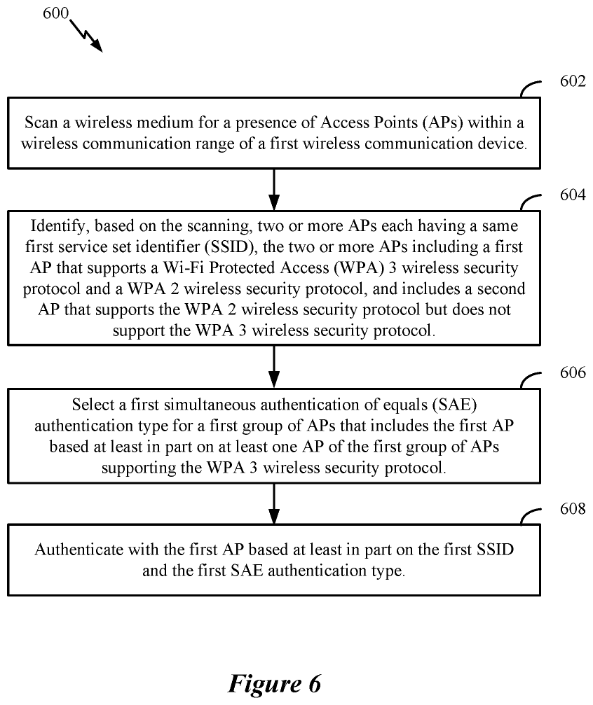

FIG. 6 shows a flowchart illustrating an example process 600 that supports improved security in wireless communication according to some implementations. The operations of the process 600 may be implemented by a STA or its components as described herein. For example, the process 600 may be performed by a wireless communication device such as the wireless communication device 200 described above with reference to FIG. 2. In some implementations, the process 600 may be performed by a STA, such as one of the STAs 104 and 304 described above with reference to FIGS. 1 and 3B, respectively.

In some implementations, in block 602, the wireless communication device scans a wireless medium for a presence of Access Points (APs) within a wireless communication range of a first wireless communication device. In some implementations, in block 604, the wireless communication device identifies, based on the scanning, two or more APs each having a same first Service Set Identifier (SSID), the two or more APs including a first AP that supports a Wi-Fi Protected Access (WPA) 3 wireless security protocol and a WPA 2 wireless security protocol, and includes a second AP that supports the WPA 2 wireless security protocol but does not support the WPA 3 wireless security protocol. In some implementations, in block 606, the wireless communication device selects a first simultaneous authentication of equals (SAE) authentication type for a first group of APs that includes the first AP based at least in part on at least one AP of the first group of APs supporting the WPA 3 wireless security protocol. In some implementations, in block 608, the wireless communication device authenticates with the first AP based at least in part on the first SSID and the first SAE authentication type.

In some implementations, the first AP is associated with a 5 GHz frequency band and the second AP is associated with a 2.4 GHz frequency band. In some implementations, the first group of APs includes the second AP. In some implementations, the second AP is in a second group of APs which does not include the first AP.

In some implementations, the process 600 further includes providing results of the scanning to the user interface of the wireless communication device, where the results include the first group of APs, and receiving a request from a user interface of the wireless communication device to authenticate with an AP of the first group of APs, where authenticating with the first AP is in response to receiving the request. In some aspects, receiving the request includes receiving a selection of the first group of APs from the user interface.

In some implementations, authenticating with the first AP in block 608 includes sending a request to a supplicant of the wireless communication device, where the request indicates the first SSID and the first SAE authentication type. In some aspects, the supplicant authenticates with the first AP based at least in part on the first SAE authentication type and the first SSID.

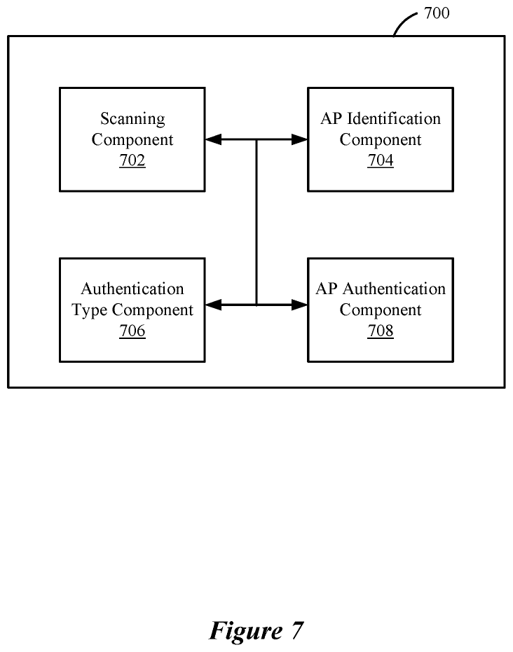

FIG. 7 shows a block diagram of an example wireless communication device 700 that supports improved security in wireless communication according to some implementations. In some implementations, the wireless communication device 700 is configured to perform the process 600 described above with reference to FIG. 6. The wireless communication device 700 may be an example implementation of the wireless communication device 200 described above with reference to FIG. 2. For example, the wireless communication device 700 can be a chip, SoC, chipset, package or device that includes at least one processor (such as the processor 202), at least one modem (for example, a Wi-Fi (IEEE 802.11) modem or a cellular modem such as the modem 204), at least one memory (such as the memory 208), and at least one radio (such as the radio 206). In some implementations, the wireless communication device 700 can be a device for use in a STA, such as one of the STAs 104 and 304 described above with reference to FIGS. 1 and 3B, respectively. In some other implementations, the wireless communication device 700 can be a STA that includes such a chip, SoC, chipset, package or device as well as at least one antenna (such as the antennas 322).

The wireless communication device 700 includes a scanning component 702, an AP Identification component 704, an authentication type component 706, and an AP authentication component 708. Portions of one or more of the components 702, 704, 706, and 708 may be implemented at least in part in hardware or firmware. For example, the scanning component 702 may be implemented at least in part by a modem (such as the modem 202). In some implementations, at least some of the components 702, 704, 706, and 708 are implemented at least in part as software stored in a memory (such as the memory 208). For example, portions of one or more of the components 702, 704, 706, and 708 can be implemented as non-transitory instructions (or “code”) executable by a processor (such as the processor 206) to perform the functions or operations of the respective module.

The scanning component 702 is configured to scan a wireless medium for a presence of access points (APs) within a wireless communication range of the wireless communication device.

The AP Identification component 704 is configured to identify, based on the scanning, two or more APs each having a same first Service Set Identifier (SSID), the two or more APs including a first AP that supports a Wi-Fi Protected Access (WPA) 3 wireless security protocol and a WPA 2 wireless security protocol, and includes a second AP that supports the WPA 2 wireless security protocol but does not support the WPA 3 wireless security protocol.

The authentication type component 706 is configured to select a first simultaneous authentication of equals (SAE) authentication type for a first group of APs that includes the first AP based at least in part on at least one AP of the first group of APs supporting the WPA 3 wireless security protocol.

The AP authentication component 708 is configured to authenticate with the first AP based at least in part on the first SSID and the first SAE authentication type.

As used herein, “or” is used intended to be interpreted in the inclusive sense, unless otherwise explicitly indicated. For example, “a or b” may include a only, b only, or a combination of a and b. As used herein, a phrase referring to “at least one of” or “one or more of” a list of items refers to any combination of those items, including single members. For example, “at least one of: a, b, or c” is intended to cover the examples of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

What is claimed is:

1. A method for wireless communication by a first wireless station (STA), comprising:
scanning a wireless medium for a presence of access points (APs) in a wireless communication range of the first wireless STA;
identifying, based on the scanning, two or more APs each having a same first Service Set Identifier (SSID), the two or more APs including a first AP that supports a Wi-Fi Protected Access (WPA) 3 wireless security protocol and a WPA 2 wireless security protocol and including a second AP that supports the WPA 2 wireless security protocol but does not support the WPA 3 wireless security protocol;
selecting a first simultaneous authentication of equals (SAE) authentication type for a first group of APs that includes the first AP based on at least one AP of the first group of APs supporting the WPA 3 wireless security protocol; and
authenticating with the first AP based at least in part on the first SSID and the first SAE authentication type.

2. The method of claim 1, wherein the first AP is associated with a 5 GHz frequency band, and the second AP is associated with a 2.4 GHz frequency band.

3. The method of claim 2, wherein the first group of APs further includes the second AP.

4. The method of claim 2, wherein the second AP is in a second group of APs that does not include the first AP.

5. The method of claim 1, further comprising:
providing results of the scanning to the user interface of the first wireless STA, the results indicating the first group of APs;
receiving a request from a user interface of the first wireless STA to authenticate with an AP of the first group of APs wherein the authentication with the first AP is responsive to receiving the request.

6. The method of claim 5, wherein receiving the request comprises receiving a selection of the first group of APs from the user interface.

7. The method of claim 1, wherein authenticating with the first AP comprises sending a request to a supplicant of the first wireless STA, the request indicating the first SSID and the first SAE authentication type.

8. The method of claim 7, wherein the supplicant authenticates with the first AP based at least in part on the first SAE authentication type and the first SSID.

9. A first wireless station (STA), comprising:
at least one processor; and
at least one memory communicatively coupled with the at least one processor and storing processor-readable code that, when executed by the at least one processor, is configured cause the first wireless STA to:
scan a wireless medium for a presence of access points (APs) in a wireless communication range of the first wireless STA;
identify, based on the scanning, two or more APs each having a same first Service Set Identifier (SSID), the two or more APs including a first AP that supports a Wi-Fi Protected Access (WPA) 3 wireless security protocol and a WPA 2 wireless security protocol and including a second AP that supports the WPA 2 wireless security protocol but does not support the WPA 3 wireless security protocol;
select a first simultaneous authentication of equals (SAE) authentication type for a first group of APs that includes the first AP based at least in part on at least one Ap of the first group of APs supporting the WPA 3 wireless security protocol; and
authenticate with the first AP based at least in part on the first SSID and the first SAE authentication type.

10. The first wireless STA of claim 9, wherein the first AP is associated with a 5 GHz frequency band, and the second AP is associated with a 2.4 GHz frequency band.

11. The first wireless STA of claim 10, wherein the first group of APs further includes the second AP.

12. The first wireless STA of claim 10, wherein the second AP is in a second group of APs that does not include the first AP.

13. The first wireless STA of claim 9, wherein the at least one processor in conjunction with the at least one modem, is further configured to:
provide results of the scanning to the user interface of the first wireless STA, the results including the first group of APs;
receive a request from a user interface of the first wireless STA to authenticate with an AP of the first group of APs; and
wherein authenticating with the first AP is in response to receiving the request.

14. The first wireless STA of claim 13, wherein receiving the request comprises receiving a selection of the first group of APs from the user interface.

15. The first wireless STA of claim 9, wherein authenticating with the first AP comprises sending a request to a supplicant of the first wireless STA, the request indicating the first SSID and the first SAE authentication type.

16. The first wireless STA of claim 15, wherein the supplicant authenticates with the first AP based at least in part on the first SAE authentication type and the first SSID.

17. The first wireless STA of claim 1, further comprising:
at least one transceiver coupled to the at least one modem;
at least one antenna coupled to the at least one transceiver to wirelessly transmit signals output from the at least one transceiver and to wirelessly receive signals for input into the at least one transceiver; and
a housing that encompasses the at least one modem, the at least one processor, the at least one memory, the at least one transceiver and at least a portion of the at least one antenna.

18. A first wireless station (STA), comprising:
means for scanning a wireless medium for a presence of access points (APs) in a wireless communication range of the first wireless STA;
means for identifying, based on the scanning, two or more APs each having a same first Service Set Identifier (SSID), the two or more APs including a first AP that supports a Wi-Fi Protected Access (WPA) 3 wireless security protocol and a WPA 2 wireless security protocol and including a second AP that supports the WPA 2 wireless security protocol but does not support the WPA 3 wireless security protocol;
means for selecting a first simultaneous authentication of equals (SAE) authentication type for a first group of APs that includes the first AP based on at least one AP of the first group of APs supporting the WPA 3 wireless security protocol; and
means for authenticating with the first AP based at least in part on the same first SSID and the first SAE authentication type.

19. The first wireless STA of claim 18, wherein first group of APs further includes the second AP.

20. The first wireless STA of claim 18, wherein the second AP is in a second group of APs that does not include the first AP.
